(19) United States
(12) Patent Application Publication
(10) Pub. No.: US 2006/0011306 A1
(43) Pub. Date: Jan. 19, 2006

(54) Method and apparatus for making bonded discs

(75) Inventor: Martin Eichlseder, Tettenweis (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 10/667,146

(22) Filed: Sep. 19, 2003

(30) Foreign Application Priority Data
Sep. 20, 2002 (DE) 102 43 663.0-53

(51) Int. Cl. B29C 65/00

(52) U.S. Cl. 156/556; 156/275.5; 156/567

(57) ABSTRACT

In a method and apparatus for making bonded discs, at least one of two substrates is coated with adhesive and positioned in a transfer station. A central handling system grabs the substrates from the transfer station and deposits them a joining station for subsequent bonding. The central handling system includes a carousel having gripper arms which are moved by the carousel horizontally and/or vertically into a number of indexing positions, wherein at least one gripper arm has two gripper elements arranged behind one another in radial direction. After bonding, the joining station is opened and the joined disc is withdrawn and subjected to an inspection. Handling of the substrates and the joined disc is realized in a circular manner for transport along two concentric circular paths of different diameter, thereby defining an inner circle and an outer circle, with one substrate transported on the inner circle and the other substrate transported on the outer circle.

### CROSS-REFERENCES TO RELATED APPLICATIONS

This application claims the priority of German Patent Application, Ser. No. 102 43 663.0-53, filed Sep. 20, 2002, pursuant to 35 U.S.C. 119(a)-(d), the disclosure of which is incorporated herein by reference.

### BACKGROUND OF THE INVENTION

The present invention relates, in general, to a method and apparatus for making bonded discs of two substrates, in particular for making DVDs (DVD audio, DVD video, DVD-R, DVD-D and other DVD formats), UDOs (Ultra Density Optical) discs or blueray discs or other types of optical data carriers.

In producing a DVD, UDO or blueray disc two substrates are bonded to obtain a finished optical data carrier. Both substrates are hereby made in an injection molding machine, transferred to one or more metallizing stations in correspondence to the format of the respective data carrier, for application of one or more metal coatings, and immediately thereafter or following a temporary storage of both substrates supplied to a bonding station. The substrates pass in the bonding station initially an adhesive application station in which one or both substrates to be joined together are coated with an appropriate adhesive. Subsequently, the substrates are advanced to one or more joining stations in which the substrates are placed upon one another and bonded together. Examples of adhesives used by adhesive application station typically include hot melt, molten hot-melt adhesive, or a liquid, normally low-viscous UV-curing adhesive. Hot-melt adhesive is applied by a roller system equipped with a doctor blade, whereby the substrates move side-by-side or in sequence under the doctor blade. The UV-curing adhesive is applied by a metering needle onto one or both substrates. The substrates are joined together in the joining station and the adhesive is cured. In the case of the UV-curing adhesive, the application of UV radiation is additionally needed.

European Pat. No. EP 0 735 530 A1 discloses a bonding station in which two DVD substrates are initially moved side-by-side to an adhesive application station of the hot melt type. Once the adhesive has been supplied, one of the substrates (substrate A) is transported to a station in which a UV-curable adhesive is filled in a recess of the substrate. The other substrate (substrate B) is then transferred from a substrate transfer device (so-called pick-and-place tool) to a turning device, also called flip station, and rotated there by 180°, so that the side of the substrate having the applied adhesive faces downwards. This substrate is then moved by the turning device over the first substrate and stacks it thereon. The so-joined DVD substrates are seized by a further pick-and-place tool and placed in a press where both joined DVD substrates are pressed together under pressure to make the finished DVD. Pressure application is implemented in a vacuum chamber having a bottom part with a glass window which is transparent to UV-radiation so that the DVD can be irradiated with ultraviolet for curing the UV-curing adhesive in the recess. Subsequently, the finished DVD can be extracted from the press station. Normally, the DVDs are then carried onto a quality inspection station to check for defects and, depending on the inspection, placed onto spindles for acceptable products (spindles for good parts, called “good-item spindles”) or onto spindles for parts of poor quality (called “bad-item spindles”). This type of conventional bonding station has many drawbacks. Since the DVD substrates are transported through the bonding station side-by-side before being joined together, there is a great demand for space. Moreover, the bonding station requires the use of several pick-and-place tools between the stations for adhesive application, joining, pressing and quality inspection. Each pick-and-place tool requires space so that again the demand for space is great. Also, as the transport devices and the pick-and-place tools must be synchronized to one another during operation to provide the joining station with an A substrate and a B substrate in the correct production cycle, possibly simultaneously, the electronic control and the software become complex in order to accomplish a proper interaction of the mechanical components in the correct production cycle. Further, the roller system in the hot-melt adhesive application station has to be sized wide enough to enable a simultaneous coating of both substrates A and B with adhesive. As the doctor blade becomes slightly bent hereby during application of the adhesive onto the neighboring substrates, the adhesive is applied at an uneven pressure onto the substrates. The pressure is higher in the middle of the doctor blade than at the margins so that the substrates are coated unevenly with adhesive, leading to unbalances during bonding of the substrates.

International publication no. WO 01/63605 A1 discloses a bonding station which applies a hot-melt adhesive by a roller system with a doctor blade onto the DVD substrates, whereby the DVD substrates are transported to the adhesive application station in a row behind one another (A-B-A-B-A-B- . . . ). After leaving the adhesive application station, the substrates coated with adhesive are simultaneously seized by a tandem gripper and transferred to one of two joining stations. The joining stations are made of two closeable halves, with one half forming the bottom part and the other half forming the lid. The A substrate is placed in one half and the B substrate is placed in the other half. The substrates are suitably fixed and centered in both halves, e.g. on vacuum plates with centering pins. Subsequently, the lid part is moved onto the bottom part and both halves form a chamber which can be evacuated. The substrates A and B are joined together in this chamber and subjected to additional pressure to compress them. After the hot-melt adhesive has cured, the chamber can be opened and the finished DVD can be removed by a pick-and-place tool. Then, the DVD undergoes a quality inspection, normally a scanner, and is deposited, in dependence on the result of the inspection, onto a spindle for acceptable items (good-item spindle) or a spindle for unacceptable item (bad-item spindle). This bonding station has the drawback that after the adhesive application, several gripper systems, such as tandem gripper and a pick-and-place tool, are needed during transfer to the individual work stations. These gripper systems require a large operating area in the bonding station. Moreover, the movements of the tandem gripper and the pick-and-place tool must be synchronized to suit the production cycle.

European Pat. Nos. 0 791 666 A2 and 0 791 667 A2 disclose the provision of a central handling system implemented as turntable which has several gripper arms with gripper elements for receiving, holding and depositing substrates. The gripper arms have a same radial length and are mounted in a plane at a certain angle relative to one another to the turntable. Thus, the gripper elements are disposed on a circle with a certain radius. Arranged on the circle are various transfer and processing stations. Through vertical movement of the turntable, the substrates can be lifted from or deposited on the respective transfer or processing station. As the turntable rotates, the individual gripper arms are moved in circumferential direction to transport the substrates from station to station. One of the gripper arms may be moved separately in circumferential direction in relation to the simultaneous movement of the remaining gripper arms so as to allow this gripper arm to target alternatingly two stations situated on a circle, typically the good-item spindle, on the one hand, and the bad-item spindle, on the other hand. This type of central handling system is unsuitable for bonding DVD substrates, because there are no provisions to transport two DVD substrates in suitable manner or to allow simultaneous grabbing of two substrates in a transfer station and to deposit them in a joining station.

It would therefore be desirable and advantageous to provide an improved method and apparatus for making bonded discs, to obviate prior art shortcomings and to enable a bonding of DVD substrates in a simple manner within minimum space requirements and short cycle periods.

### SUMMARY OF THE INVENTION

According to one aspect of the present invention, a method of making bonded discs, in particular optical data carriers such as DVD, UDO disc or blueray disc, includes the steps o producing two substrates, coating at least one of the substrates with an adhesive, placing the substrates in standby position in a transfer station, transporting the substrates from the transfer station to a joining station, depositing the substrates in the joining station, bonding the substrates, opening the joining station and withdrawing the joined disc, inspecting the joined disc for compliance with quality standards, and placing the disc on a stack of acceptable discs or on a stack or rejected discs in dependence on the outcome of the inspection, wherein the substrates and the joined disc are handled in a circular manner for transport along two concentric circular paths of different diameter, thereby defining an inner circle and an outer circle, with one substrate transported on the inner circle and the other substrate transported on the outer circle.

In this way, several processing stations can be targeted within a shortest possible time and operated simultaneously. This has a positive effect on the cycle period.

According to another feature of the present invention, at least one of the substrates can be metallized before executing the adhesive application step.

According to another aspect of the present invention, an apparatus for making bonded discs of two substrates, in particular for making optical data carriers such as DVD, UDO disc or blueray disc, includes an adhesive application station for coating at least one of the substrates with an adhesive; a plurality of processing stations, disposed downstream of the adhesive application station, for further handling the substrates, said processing stations arranged about a circle and including a transfer station for placing the substrates in a standby position for further processing, at least one joining station for joining and bonding the substrates to produce a finished disc, at least one quality inspection station for checking the disc for acceptance or rejection, a first delivery station for receiving the disc, when the disc is acceptable, and a second delivery station for receiving the disc, when the disc is unacceptable; and a central handling system in the form of a carousel which includes a plurality of gripper arms and is constructed to move the gripper arms in horizontal and/or vertical direction into a number of indexing positions, wherein a first type of the gripper arms has two gripper elements arranged behind one another in radial direction so as to enable the second gripper arm to sweep with the gripper elements over two concentric circles of different diameter, when the gripper arms are moved in circumferential direction.

According to another feature of the present invention, the two gripper elements of the second gripper arm have a distance from another to allow a simultaneous seizing of the substrates.

As alternative, or in addition thereto, the carousel may have a gripper arm constructed for telescopic movement in radial direction or including a part that moves in radial direction.

According to another feature of the present invention, there may be provided one or more additional joining stations, wherein each of the joining stations is comprised of two halves which are provided for receiving the substrates and configured to open up and close, wherein the joining stations are so positioned that their halves extend behind one another, when the halves are in open position, with one half situated on the inner one of the two concentric circles and the other half situated on the outer one of the two concentric circles.

According to another feature of the present invention, the first and second gripper arms number a total of five gripper arms which are positioned in spaced-apart relationship in such a manner that four gripper arms are spaced from one another at an angle of 60° and two gripper arms are spaced from one another at an angle of 120°.

According to another feature of the present invention, the processing stations are disposed on a circle in spaced-apart relationship at an angle of 60°, whereby the carousel is indexed to rotate the gripper arms in clockwise direction as well as counterclockwise direction to pause by these processing stations as well as to pause in neutral in-between positions.

Depending on the DVD to be produced, it may be necessary to supply so-called dummy substrates, i.e. uncoated substrates, or spacers to the central handling system. Spacers are necessary when the DVD is configured without stacking blocks to maintain stacked DVDs at a distance on the spindles.

According to another feature of the present invention, the drive of the carousel may be constructed to move the first and second gripper arms in the horizontal direction, and there may be a further drive for separately moving the first and second gripper arms in the vertical direction. In this way, the flexibility of the bonding station can be enhanced.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic top plan view of one embodiment of an apparatus for making bonded discs in accordance with the present invention, showing a central handling system with gripper arms positioned in the processing stations;

FIG. 2 is a schematic top plan view of the apparatus for making bonded discs, showing the central handling system with the gripper arms in neutral position between the processing stations;

FIGS. 3.1-3-24 are schematic top plan view of the apparatus according to the invention, showing the operation and process sequence of the components of the apparatus;

FIG. 4 is a schematic illustration of a central handling system with modified gripper arms;

FIG. 5 is a schematic illustration of a central handling system with a further variation of gripper arms; and

FIG. 6 is a schematic top plan view of another embodiment of an apparatus for making bonded discs in accordance with the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

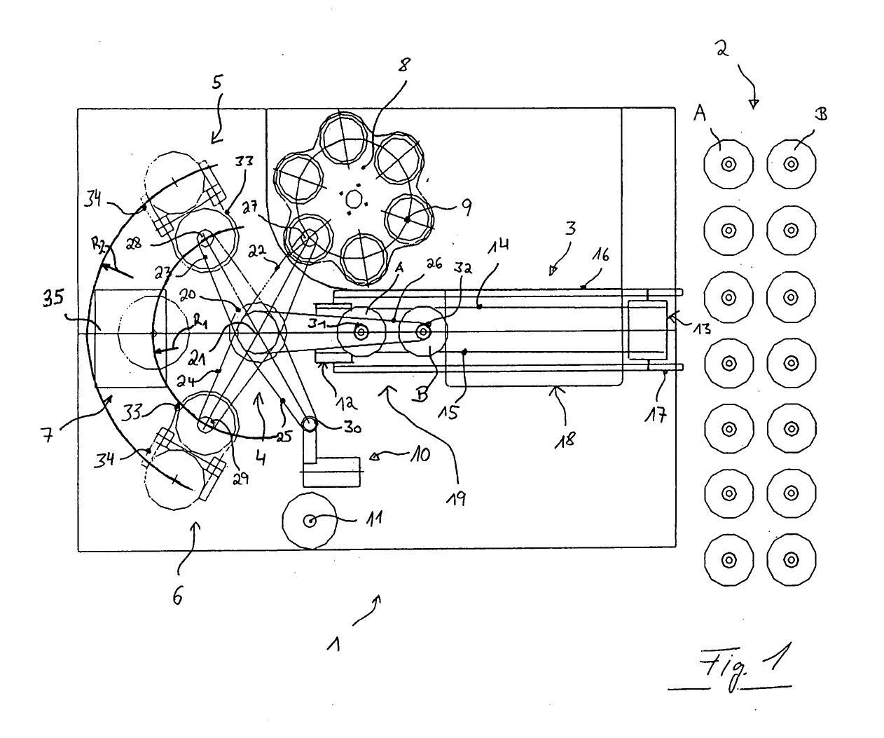

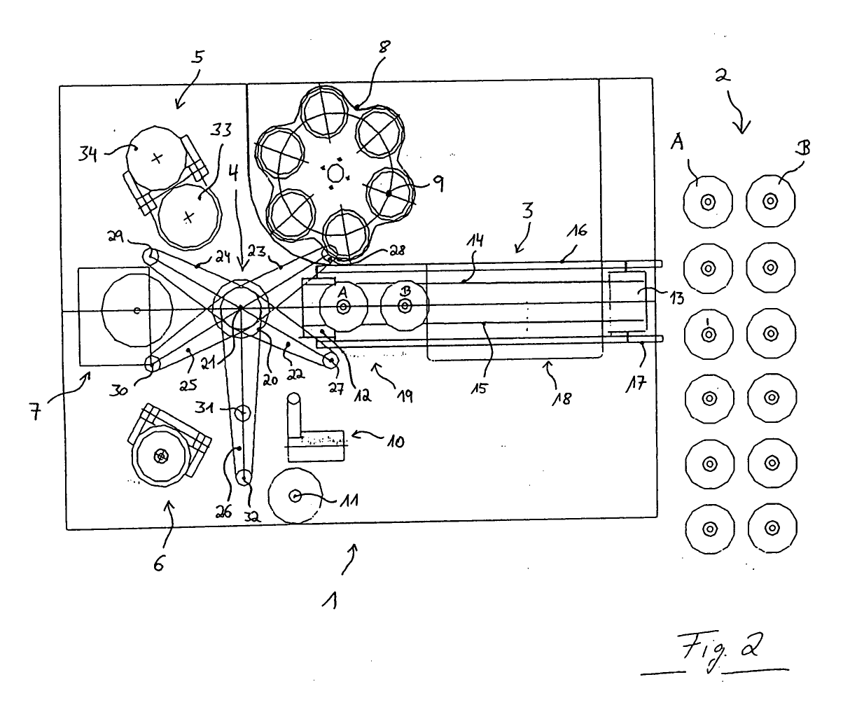

Turning now to the drawing, and in particular to FIG. 1, there is shown a schematic top plan view of an apparatus for making bonded discs in accordance with the present invention, generally designated by reference numeral 1 and being referred to in the following as hot-melt bonder. The hot-melt bonder 1 includes a substrate reservoir 2, which contains substrates A and B, a linear guide 3 which receives the substrates A, B from the reservoir 2 and moves them to a central handling system 4 two vacuum joining stations 5, 6, a quality inspection station 7 including, e.g. a scanner, a turntable 8 with six stacking spindles 9 arranged in spaced-apart relationship along a circle and intended for receiving acceptable finished discs (referred to in the following as “good-item spindles”), a flip station 10 as well as a spindle 11 for receiving unacceptable finished discs (referred to in the following as “bad-item spindles”). The linear guide 3 can be implemented, e.g. by a walking beam or, as shown in FIG. 1, may include round cord belts 14, 15 which are trained about rollers 12, 13. The rollers 12, 13 are rotatably mounted in a frame with side walls 16, 17 and operated by a drive unit (not shown). Situated at a position along the linear guide 3 is an adhesive application station 18 by which the substrates can be coated with a molten hot-melt adhesive or an UV-curing adhesive. A substrate transfer station 19 is positioned downstream of the adhesive application station 18 and includes centering pins (not shown), which can move in vertical direction for lifting the substrates A, B from the belts 14, 15 upwards to a standby position in which the substrates A, B are ready for transfer to the central handling system 4.

As shown in FIG. 1, the central handling system 4 includes a carousel 20 which is adapted to index, or steppingly rotate about a vertical rotation axis 21 clockwise as well as counterclockwise and movable in vertical direction by a suitable drive assembly (not shown). The carousel 20 includes four gripper arms 22, 23, 24, 25 and one gripper arm 26 which can move in vertical direction as well as horizontal direction, in particular in circumferential direction, whereby the gripper arms 22, 23, 24, 25 are shorter than the gripper arm 26. At their end distal to the carousel 20, the gripper arms 22, 23, 24, 25, are provided with gripper elements 27, 28, 29, 30, respectively, and the gripper arm 26 is provided with gripper elements 31, 32, whereby the gripper elements 27, 28, 29, 30, 31, 32 may be constructed, e.g., as vacuum suction units. The gripper elements 27, 28, 29, 30, 31 of the gripper arms 22, 23, 24, 25, 26 are disposed in spaced apart relationship along a circle with a diameter R₁, whereas the gripper element 32 of the gripper arm 26 is disposed on a circle with a diameter R₂ which is greater than R₁ and dimensioned enough to enable both substrates A, B to be transported along the two circles without touching one another.

The vacuum joining stations 5, 6 have each two halves 33, 34 which can be moved into an open position and moved into a closed position and which are arranged in relation to the carousel 20 in such a manner that the half 33 is situated on the inner circle and the half 34 is situated on the outer circle. In this way, the substrates A, B can be placed simultaneously in both halves 33, 34 of the joining stations 5, 6. The mode of operation of the joining stations 5, 6 is generally known to the artisan (e.g. International publication no. WO 01/63605 A1) so that a further discussion thereof is omitted for the sake of simplicity.

The substrate transfer station 19, the vacuum joining stations 5, 6, the quality inspection station 7, one good-item spindle 9 as well as the substrate receiving point of the flip station 10 are arranged along a circle in six positions that are separated by one another by a 60° angle. The five gripper arms 22, 23, 24, 25, 26 are arranged on the carousel 20 in spaced apart relationship such that four 60° angles and one 120° angle are defined, whereby the bisecting line 35 of the 120° angle is in alignment with the center line of the long gripper arm 26.

FIG. 1 shows each gripper arm 22, 23, 24, 25, 26 of the carousel 20 in an operative position in which each gripper arm 22, 23, 24, 25, 26 is disposed in one processing station. In contrast thereto, FIG. 2 shows the gripper arms 22, 23, 24, 25, 26 in a neutral position in which the gripper arms 22, 23, 24, 25, 26 are rotated clockwise by 90° and situated between the processing stations. The gripper arms 22, 23, 24, 25, 26 thus assume a mid-position between the 60° positions of the processing stations. This neutral position of the gripper arms 22, 23, 24, 25, 26 will subsequently be referred to as 30°-position.

The mode of operation of the apparatus according to the invention will now be described in more detail with reference to FIGS. 3.1-3.24. For sake of simplicity, it is assumed that the gripper arms 22, 23, 24, 25, 26 are moved by the carousel 20 in a vertical movement for grabbing and depositing the substrates A, B so that this movement will not be referred to when explaining the various process steps.

In FIG. 3-1, all substrates A, B are still retained in the substrate reservoir station 2. The gripper arms 22, 23, 24, 25, 26 are positioned in such a manner than the long gripper arm 26 with its two gripper elements 31, 32 is caused to halt over the substrate transfer station 19. When transferred to the substrate transfer station 19, the two substrates A1, B1 are picked up by the gripper elements 31, 32 of the long gripper arm 26. This is shown in FIG. 3-2. After clockwise rotation of the gripper arms 22, 23, 24, 25, 26 by 120°, the substrates A1, B1 are deposited in the joining station 6, as shown in FIG. 3-3. Subsequently, the carousel 20 rotates by 30° counterclockwise so that the joining station 6 is cleared and the inner half 33 can be pivoted onto the outer half 34 to shut the joining station 6, as shown in FIG. 3-4. While both substrates A1, B1 are joined and bonded to form a disc AB1, the next two substrates A2, B2 are removed from the substrate reservoir 2 and placed on the centering pins of the substrate transfer station 19 to assume the standby position. The carousel 20 turns by 30° counterclockwise to halt the gripper arms 22, 23, 24, 25, 26 over the respective 60° processing stations. This is shown in FIG. 3-5. The carousel 20 now turns counterclockwise by 60°, thereby halting the long gripper arm 26 over the substrates A2, B2, as shown in FIG. 3-6. The gripper elements 31, 32 take the substrates A2, B2 from the centering pins, and the carousel 20 rotates counterclockwise by 120° so that the substrates A2, B2 are positioned in the joining station 5 for production of disc AB2, as shown in FIG. 3-7, whereby substrate A2 is deposited in the inner half 33 and the substrate B2 is deposited in the outer half 34. Subsequently, the carousel 20 is indexed further clockwise by 30° to move the gripper arms 22, 23, 24, 25, 26 into the neutral position, shown in FIG. 3-8, to enable a closing of the joining station 5. Thus, both joining stations 5, 6 are now closed.

Next, the carousel 20 is indexed by 30° clockwise to halt the gripper arms 22, 23, 24, 25, 26 again in the 60° processing stations and the joining station 6 is opened. This stage is shown in FIG. 3-9.

Next, the carousel 20 rotates clockwise by 60° to position the long gripper arm 26 over the new substrates A3, B3, which have been moved in the meantime to the standby position on the centering pins of the substrate transfer station 19, while the short gripper arm 24 is halted over the previously bonded disc AB1. Thus, the substrates A3, B3 as well as the disc AB1 can now be handled by the central handling system 4, as shown in FIG. 3-10. The carousel 20 is then indexed or rotated clockwise by 120° to cause the long gripper arm 26 to move the substrates A3, B3 into the previously cleared joining station 6, while the short gripper arm 24 moves the bonded disc AB1 into a parking position adjacent the closed joining station 5 (FIG. 3-11). After depositing the substrates A3, B3 into the respective halves 33, 34 of the joining station 6, the carousel 20 is rotated counterclockwise by 30° to move the gripper arms 22, 23, 24, 25, 26 into the neutral position, as shown in FIG. 3-12. Thus, the space above the inner half 33 of the joining station 6 is cleared so that the half 33 can be flipped over the outer half 34 to close the joining station 6 and to execute the joining and bonding operations to produce disc AB3.

The carousel 20 is then indexed counterclockwise by 30° to move the gripper arms 22, 23, 24, 25, 26 to the respective 60° processing stations, whereby the gripper arm 24 with the bonded disc AB1 is halted adjacent the quality inspection station 7. At the same time, the joining station 5 is opened and the previously bonded disc AB2 is readied in the inner half 33 for further processing. This stage is shown in FIG. 3-13. After depositing the disc AB1 in the quality inspection station 7, the carousel 20 is rotated counterclockwise by 60° so that the long gripper arm 26 is again positioned in the substrate transfer station 19 to take new substrates A4, B4, which have been placed on the centering pins in the meantime. At the same time, the short gripper arm 23 removes the bonded disc AB2 from the joining station 5 (FIG. 3-14). Next, the carousel 20 is indexed to move the substrates A4, B4 to the thus cleared joining station 5 for placement into the halves 33, 34, while the disc AB2 is parked adjacent the joining station 6, as shown in FIG. 3-15. The short gripper arm 22 is hereby halted adjacent the quality inspection station 7 to pick up the inspected disc AB1.

Subsequently, the carousel 20 is indexed clockwise by 30° to move the gripper arms 22, 23, 24, 25, 26 into the neutral position between the processing stations so that the space above the joining station 5 is cleared to enable the inner half 33 to move over the outer half 34 (FIG. 3-16). At the same time, new substrates A5, B5 are moved to the substrate transfer station 19.

The carousel 20 is now rotated clockwise by 30° so that the disc AB2 can be carried onto the quality inspection station 7, while the previously inspected disc AB1 is held in the joining station 5. The joining station 6 is opened again, with the produced disc AB3 readied in the inner half 33 for subsequent transfer. This stage is shown in FIG. 3-17.

Subsequently, the carousel 20 is indexed clockwise by 60° so that the disc AB1 is positioned by the gripper arm 22 over the good-item spindle 9, while the long gripper arm 26 is halted over the substrates A5, B5 and the short gripper arm 24 has reached the joining station 6. When disc AB1 has passed inspection and is considered acceptable, the disc AB1 is stacked on the good-item spindle 9, as shown in FIG. 3-18. In the event, disc AB1 has failed the inspection and is considered unacceptable, the gripper arm 22 holds on to the disc AB1 (FIG. 3-19). The carousel 20 is then rotated clockwise by 120° so that the previously bonded disc AB3 is withdrawn from the joining station 6 and moved to the still closed joining station 5, while the substrates A5, B5 are deposited in the joining station 6 (FIG. 3-20). The inspected disc AB2 can be removed by the gripper arm 25 from the quality inspection station 7. If disc AB1 has previously been considered unacceptable, the gripper arm 22 now drops the disc AB1 in the flip station 10 for subsequent transfer to the bad-item spindle 11 for unacceptable discs.

In the next step, the carousel 20 is indexed counterclockwise by 30° to move the gripper arms 22, 23, 24, 25, 26 into their neutral position so that the joining station 6 can now be closed to join and bond the substrates A5, B5 to form disc AB5, as shown in FIG. 3-21. This position corresponds to the one shown in FIGS. 34 and 3-12, with the difference that now the gripper arm 24 holds a not yet inspected disc, i.e. the disc AB3, while the gripper arm 25 holds an inspected disc, namely disc AB2. Next, the carousel 20 is rotated counterclockwise by 30° so as to assume again the 60° positions (FIG. 3-22). The disc AB3 is hereby deposited in the quality inspection station 7, while the inspected disc AB2 is positioned adjacent the joining station 6. At the same time, the joining station 5 is opened and the bonded disc AB4 is ready in the inner half 33 for subsequent transfer. The carousel 20 is now rotated counterclockwise by 60° so that the long gripper arm 26 is moved into the substrate transfer station 19 to pick up new substrates A6, B6, as shown in FIG. 3-23. The gripper arm 23 is halted over the joining station 5 to grab the disc AB4. In this position, the finished and inspected disc AB2 is situated in the flip station 10. In the event, disc AB2 has been considered “bad”, it is dropped into the flip station 10. Otherwise, if considered “good”, the gripper arm 25 holds on to the disc AB2.

Next, the carousel 20 is indexed counterclockwise by 120°, as shown in FIG. 3-24. In this indexed position, the substrates A6, B6 are deposited in the cleared joining station 5. As the gripper arm 25 with disc AB2 is now above good-item spindle 9 and stacks the disc AB2 there, if previously considered “good” in the quality inspection station 7. The position of the carousel 20 in FIG. 3-24 corresponds to the position shown in FIG. 3-7. Thus, steps 3-8 to 3-23 repeat now for a new cycle. Thus, the arrival of a finished disc to the good-item spindle 9 and of a finished disc to the bad-item spindle 11 alternates. Depending on the inspection outcome, the finished disc is then either stacked on the respective spindle or carried on further by the next 120° step and then stacked on the respective spindle.

Turning now to FIG. 4, there is shown a schematic illustration of a central handling system 4 with a modified gripper arm, here gripper arm 24 positioned in opposition to the gripper arm 22. The gripper arm 24 has a fixed arm part 24a, which is secured to the carousel 20, and a telescoping arm part 24b which moves radially in relation to the arm part 24a. The movement of the arm part 24b may be implemented by constructing the arm part 24a as cylinder of a piston-cylinder unit, while the telescoping arm part 24b represents the piston rod of the piston-cylinder unit and has one end connected to a piston 36. As an alternative, the gripper arms 22, 23, 24, 25, 26 may all be fixed in radial direction, the carousel 20 may include additional gripper arms with telescoping feature.

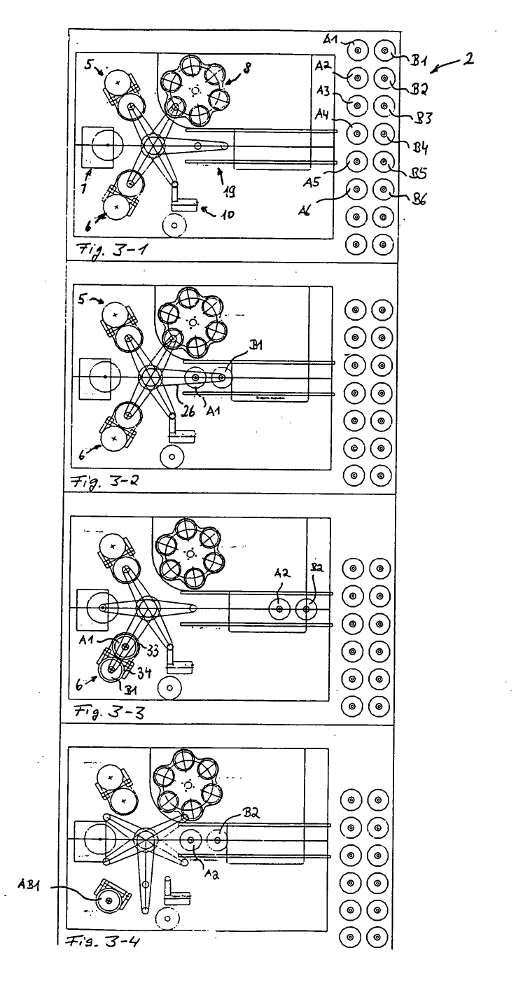

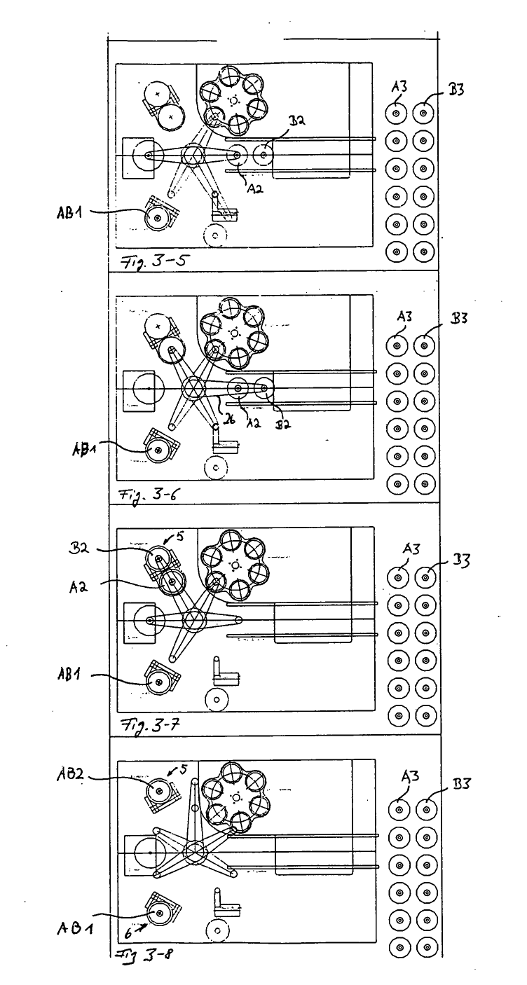

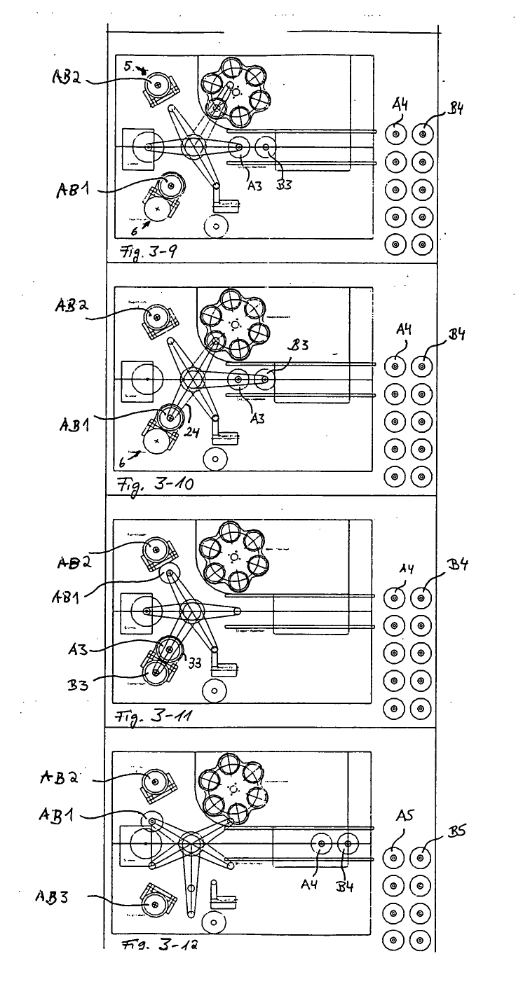

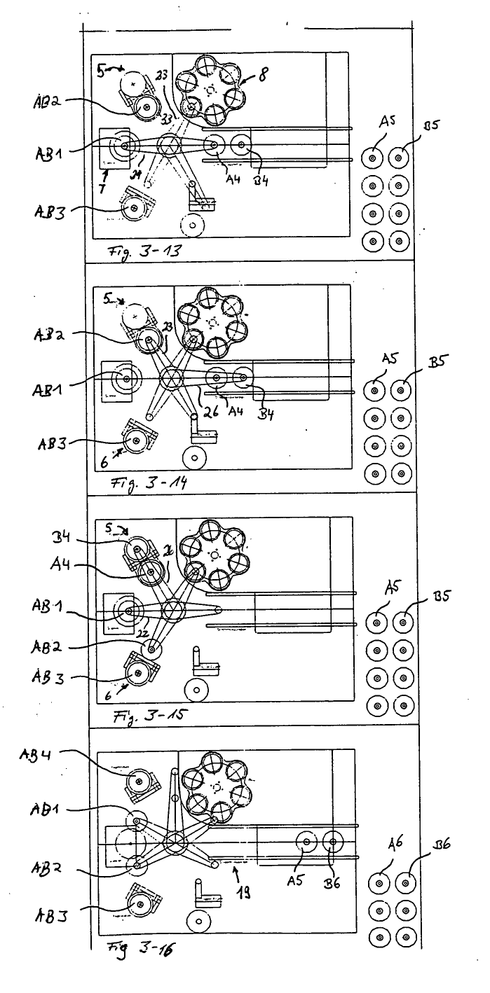

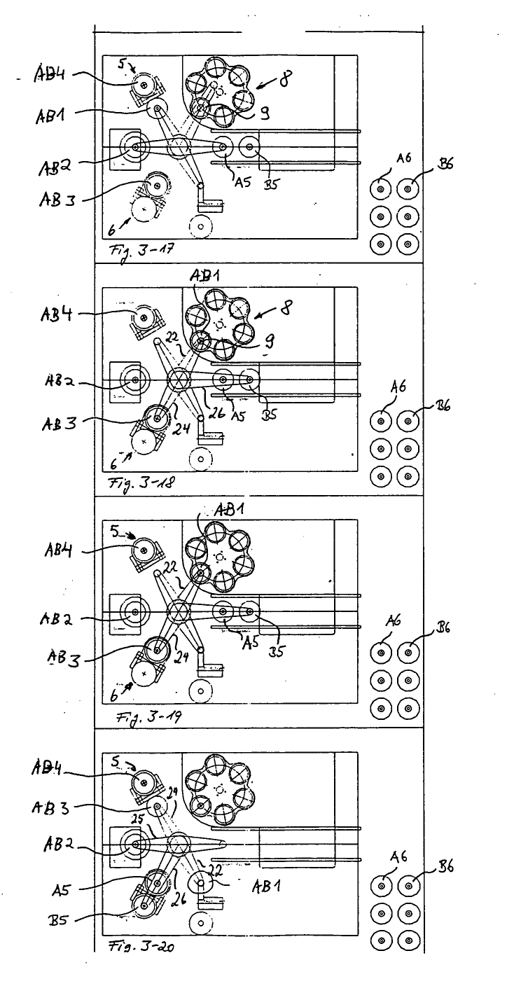

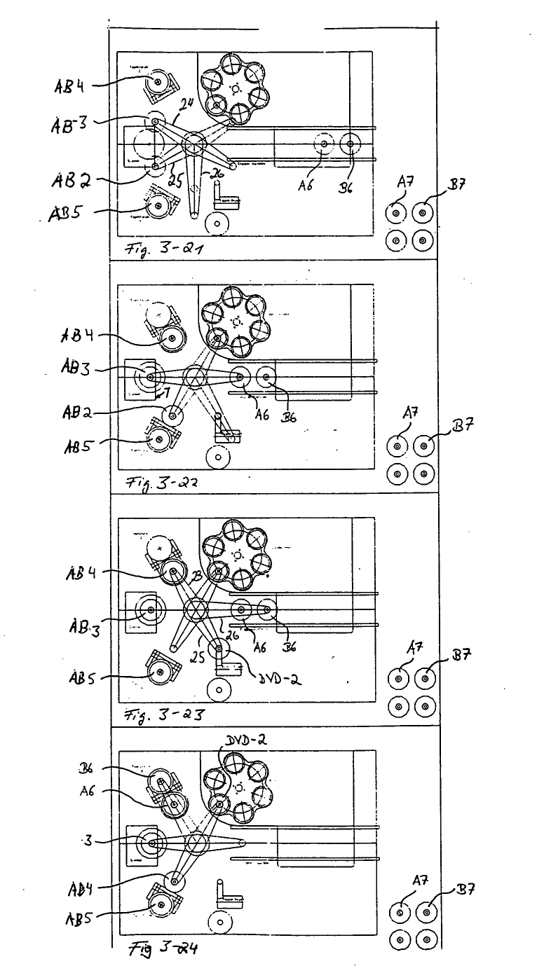

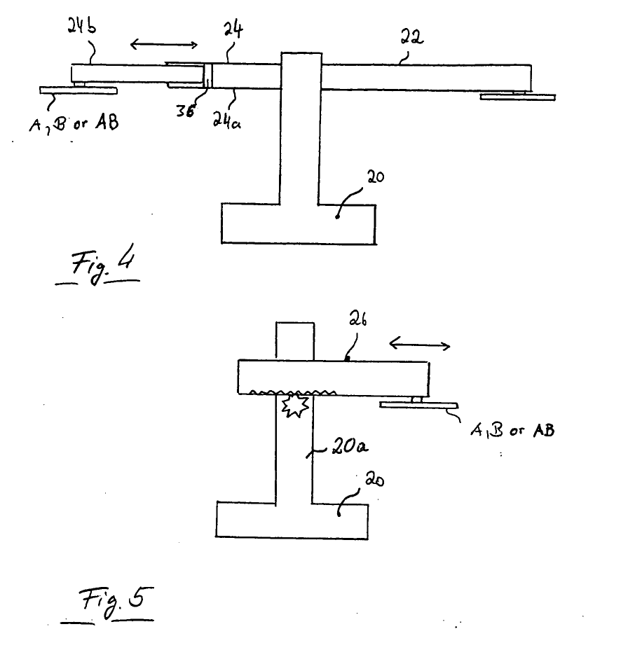

FIG. 5 shows, by way of example, a schematic illustration of a modified construction of a gripper arm, here gripper arm 26, which is configured to extend through a vertical support post 20a of the carousel 20 and is formed with a splined portion 36 for engagement with a driven gear 37. Any of the gripper arms 22, 23, 24, 25, 26 may be constructed in this manner, or, optionally, an additional gripper arm may be provided on the carousel 20 with such construction.

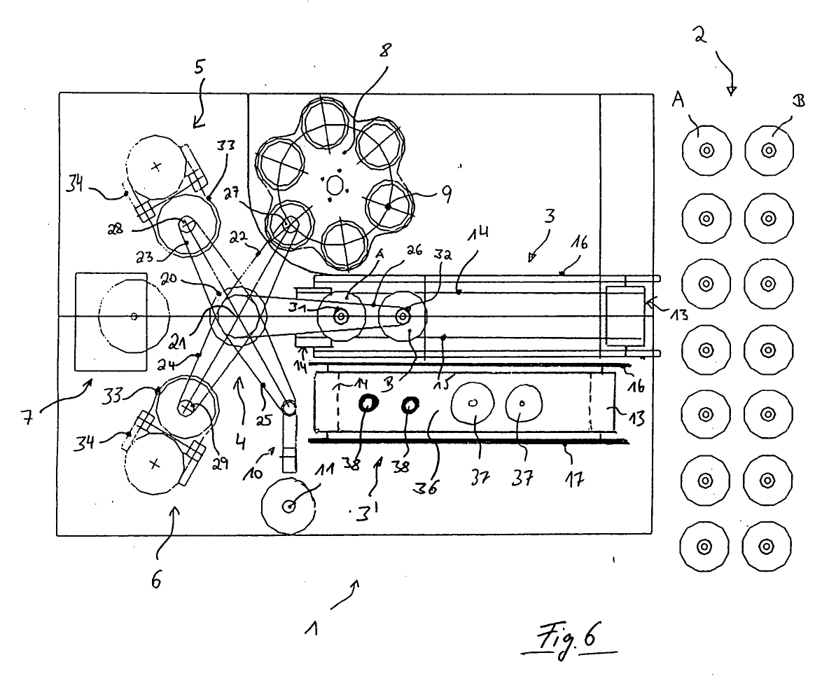

Referring now to FIG. 6, there is shown a schematic top plan view of another embodiment of an apparatus for making bonded discs in accordance with the present invention. Parts corresponding with those in FIG. 1 are denoted by identical reference numerals and not explained again. The description below will center on the differences between the embodiments. In this embodiment, provision is made for a second linear guide 3a having two side walls 16, 17 and two rollers 12, 13 disposed between the side walls 16, 17. One of the rollers 12, 13 is driven, and a belt 36 is wrapped around the rollers 12, 13 for supply of, for example, uncoated substrates 37 or spacers 38 into the production process. The spacers 38 may be placed in good-item spindles 9 between the finished discs to maintain them at a distance and thus to prevent damage.

While the invention has been illustrated and described in connection with currently preferred embodiments shown and described in detail, it is not intended to be limited to the details shown since various modifications and structural changes may be made without departing in any way from the spirit of the present invention. For example, is, of course possible, to use adhesives other than hot melt, and/or to use joining stations of different configuration commensurate with the adhesive being used. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method of making bonded discs, in particular optical data carriers such as DVD, UDO disc or blueray disc, comprising the steps of:
(1) production of two substrates;
(2) coating at least one of the substrates with an adhesive;
(3) placing the substrates in standby position in a transfer station;
(4) grabbing the substrates;
(5) transporting the substrates to a joining station;
(6) depositing the substrates in the joining station;
(7) bonding the substrates;
(8) opening the joining station and withdrawing the joined disc;
(9) inspecting compliance with quality standards of the disc; and
(10) placing the disc on a stack of acceptable discs or on a stack of rejected discs in response to the inspecting step,
wherein the steps (1) to (10) are carried out by handling the substrates in a circular manner for transport along two concentric circular paths of different diameter, thereby defining an inner circle and an outer circle, with one substrate transported on the inner circle and the other substrate transported on the outer circle.

2. The method of claim 1, and further comprising the step of metallizing at least one of the substrates between the steps (1) and (2).

3. The method of claim 1, wherein the disc is transported along one of the inner and outer circles along which the substrates are moved.

4. The method of claim 1, wherein the disc is transported along the inner circle.

5. The method of claim 1, wherein the inner and outer circles define a common center, said substrates being placed in the transfer station behind one another in radial direction, as viewed from the common center, and grabbed in the transfer station simultaneously for transport to the joining station and simultaneously deposited in the joining station.

6. The method of claim 5, wherein the steps (4)-(6) and the transport of the disc is realized by a carousel which sweeps over a circle and has gripper arms provided with gripper elements, wherein at least one gripper arm has two gripper elements arranged behind one another in radial direction for simultaneous removal of the sequentially disposed substrates from the transfer station, wherein the gripper arms are adapted to travel to a neutral position between processing stations, when the joining station is to be opened or closed.

7. The method of claim 1, wherein the joining station has two halves provided for receiving the substrates and configured to unfold to an open position and to fold together into a closed position, wherein the depositing step involves placement of one substrate in one half and placement of the other substrate in the other half of the joining station, with one half of the joining station positioned on the inner circle and the other half of the joining station positioned on the outer circle, when the halves assume the open position.

8. The method of claim 1, and further comprising the step of moving at least one of the substrates and the joined disc to a further processing station situated outside the inner and outer circles.

9. Apparatus for making bonded discs of two substrates, in particular for making optical data carriers such as DVD, UDO disc or blueray disc, comprising:
an adhesive application station for coating at least one of the substrates with an adhesive;
a plurality of processing stations, disposed downstream of the adhesive application station, for further handling the substrates, said processing stations arranged about a circle and including
a transfer station for placing the substrates in a standby position for further processing,
at least one joining station for joining and bonding the substrates to produce a finished disc,
at least one quality inspection station for checking the disc for acceptance or rejection,
a first delivery station for receiving the disc, when the disc is acceptable, and
a second delivery station for receiving the disc, when the disc is unacceptable; and
a central handling system in the form of a carousel which includes a plurality of gripper arms and is constructed to move the gripper arms in horizontal and/or vertical direction into a number of indexing positions, wherein a first type of the gripper arms has two gripper elements arranged behind one another in radial direction so as to enable the gripper elements to sweep over two concentric circles of different diameter, when the gripper arms are moved in circumferential direction.

10. The apparatus of claim 9, wherein the transfer station is adapted to receive the substrates behind one another in radial direction so that the substrates are lined up along a straight line which intersects a rotation axis of the carousel at a right angle.

11. The apparatus of claim 10, wherein the two gripper elements of the first type of gripper arms have a distance from another to allow a simultaneous grabbing of the substrates.

12. The apparatus of claim 9, wherein a second type of the gripper arms include a single gripper element which is arranged on an inner one of the two concentric circles.

13. The apparatus of claim 9, wherein the carousel has a third type of gripper arms constructed for telescopic movement in radial direction.

14. The apparatus of claim 9, and further comprising at least a second said joining station, each of the joining stations including two halves which are provided for receiving the substrates and configured to unfold into an open position and fold together into a closed position, wherein the joining stations are so positioned that their halves extend behind one another, when the halves assume the open position, with one half situated on an inner one of the two concentric circles and the other half situated on an outer one of the two concentric circles.

15. The apparatus of claim 9, wherein the carousel is constructed to halt the first and second gripper arms into indexing positions between the processing stations.

16. The apparatus of claim 9, wherein five of said gripper arms are provided in spaced-apart relationship to define therebetween four angles of each 60° and one angle of 120°.

17. The apparatus of claim 9, wherein the carousel is adapted to move the gripper arms in clockwise direction and in counterclockwise direction into indexing positions of 30°, 60° and 120°.

18. The apparatus of claim 17, wherein six of said processing stations are provided in spaced-apart relationship at an angle of 60° about a circle, with the 30° positions representing idle positions between two processing stations.

19. The apparatus of claim 16, wherein four of the five gripper arms are of a second type of gripper arms with a single gripper element and of a length which is shorter than a length of the first type of gripper arm, wherein the gripper elements of the second type of gripper arms are situated on an inner one of the two concentric circles, wherein one of the gripper elements of the first type of gripper arm is situated on the inner one of the two concentric circles and the other gripper element of the first type of gripper arm is situated on an outer one of the two concentric circles, wherein the bisecting line of the 120° angle lies on a straight line with the first type of gripper arm.

20. The apparatus of claim 9, and further comprising a first linear guide for advancing the substrates to the transfer station, and a second linear guide arranged in parallel relationship to the first linear guide for supply of spacers or uncoated substrates to the central handling system.

21. The apparatus of claim 9, wherein the carousel is constructed to move the gripper arms in horizontal direction and separately thereto in vertical direction.
